(19) United States
(12) Patent Application Publication
(10) Pub. No.: US 2024/0343311 A1
(43) Pub. Date: Oct. 17, 2024

(54) FLOOR PANELS FOR A VEHICLE AND METHODS

(71) Applicants: AUTOTECH ENGINEERING S.L., Amorebieta-Etxano (ES); GESTAMP PUEBLA II, S.A DE C.V., Puebla (MX)

(72) Inventors: Sergi MARQUEZ DURAN, Rajadell (ES); Andoni AGIRRE MENTXAKA, Issy-les-Moulineaux (FR); Vincent BARELLI, ST YON (FR); Quentin GIRAUD DE POYET, Argenteuil (FR); Unai LOPATEGI SANZ, Versailles (FR); Vanessa LOPERA CANO, Boulogne-Billancourt (FR)

(21) Appl. No.: 18/294,122

(22) PCT Filed: Jul. 29, 2022
(86) PCT No.: PCT/EP2022/071338

§ 371 Date: Jan. 31, 2024

(30) Foreign Application Priority Data
Aug. 2, 2021 (EP) 21382730.6

(51) Int. Cl. B62D 25/20; B21D 22/02; B21D 53/88; B62D 27/02

(52) U.S. Cl. CPC B62D 25/20; B21D 22/022; B21D 53/88; B62D 27/02

(57) ABSTRACT

The present disclosure relates to methods for forming a floor panel for a vehicle framework, comprising providing a main blank made of a press-hardenable steel, providing one or more first patch blanks, and welding the first patch blanks to the main blank to form a patchwork blank. The methods further comprise pressing the patchwork blank to form the floor panel, wherein the first patch blanks are arranged along a part of the main blank to form a first seat cross member, and wherein left and right portions of the first patch blanks in an area of the main blank to form an area of the floor panel to be attached to a rocker are made of a steel that is more ductile than the steel of the main blank. The present disclosure further relates to floor panels for vehicle frameworks made from a single integral piece.

The present application claims the benefit of European Patent Application n° 21 382 730.6 filed on Aug. 2, 2021.

The present disclosure relates to floor panels for a vehicle framework. The present disclosure further relates to methods for manufacturing such floor panels.

### BACKGROUND

Vehicles such as cars incorporate a structural skeleton designed to withstand all loads that the vehicle may be subjected to during its lifetime. The structural skeleton is further designed to withstand and absorb impacts, in case of e.g. collisions with other cars. The structural skeleton is also designed to be as lightweight as possible in order to reduce the emission of pollutants such as CO2 to the environment.

The structural skeleton of a car may for instance include bumper beams, pillars (e.g. A-pillar, B-pillar, C-pillar), side impact beams and rocker panels. These and other structural members may have one or more regions with a substantially U-shaped (also known as “hat”-shaped) cross section. These structural members may be manufactured in a variety of ways and may be made of a variety of materials. As indicated above, lightweight materials that improve the integrity of the vehicle during a crash while also improving the energy absorption are desired.

In the automotive industry it is generally known that at least a number of the structural members of the skeleton of a vehicle are made of ultra-high strength steels (UHSS), exhibiting an optimized maximum strength per weight unit and advantageous formability properties.

Ultra-high strength steels (UHSS) in the present disclosure may be regarded as steels having an ultimate tensile strength of at least 1000 MPa. UHSS may obtain such a high tensile strength after a heat treatment, in particular a Hot Forming process. Some UHSS require rapid cooling to obtain a martensitic microstructure and the corresponding high ultimate tensile strength. Other UHSS can obtain the high ultimate tensile strength with relatively slow cooling or even air cooling (“air hardening”). Some UHSS do not require hot forming and corresponding austenization to obtain the high ultimate tensile strength, and instead have and retain a high strength after cold forming.

UHSS may exhibit ultimate tensile strength of as high as 1500 MPa, or even 2000 MPa or more, particularly after a press hardening operation. In such an operation a steel blank is heated to above an austenization temperature, in particular to above Ac3 (the temperature at which transformation of ferrite to austenite is completed during heating), to substantially fully austenize the blank. After heating to above this temperature for a period of time, the blank is subjected to a pressing operation in which the blank is deformed. At the same time, the blank is rapidly cooled such that the blank is substantially “fully hardened” and a martensitic microstructure is obtained. Press hardening may also be referred to as “hot stamping”, or when rapid cooling is used “Hot Forming Die Quenching” (HFDQ).

The materials and components obtained may be very strong, and stiff, but at the same they can be brittle. The materials and components can hardly be deformed, and at small deformations may crack or break. Therefore, it is known to combine different materials e.g. with tailor welded blanks (TWB) in deformation processes and/or apply different thermal treatments to different areas or components to tailor the strength, stiffness and deformation properties.

Besides using appropriate materials, suitable properties in terms of crash behaviour and reduced weight can be conferred to the structural members of a vehicle by e.g. using patch welding. For instance, welding a first patch to a main piece reinforces the main piece where necessary without adding additional undesired weight. A blank to which a patch has been added is sometimes referred to as a “patchwork blank”. This is to distinguish from “tailor welded blank”, in which blanks are joined to each other through edge to edge welding.

Usually, patches are welded to the main piece by spot welding, which is a well-known and broadly used welding technology in the automotive field.

Vehicle floors for vehicle structural frameworks may comprise a plurality of different stamped or otherwise formed sheet metal components and reinforcements that need to be joined together in order to obtain the final vehicle floor. The different floor components can be produced by different hot or cold forming methods, such as cold stamping, hot stamping (also known as press hardening or hot forming die quenching), roll forming or indirect hot stamping (also known as indirect press hardening).

The assembly can be a labour intensive process and it can be challenging to maintain the desired floor geometry, when many welding operations are involved which can lead to deformation of the floor.

Furthermore, after the floor is completely assembled it must be supplied to the frame mounting line in order to assemble it to the vehicle frame. The assembled floor is a heavy and bulky component which is difficult to handle from a logistic point of view.

Additionally, with the expansion of hybrid and electric vehicles it is more and more often required that vehicle frames, such as for example, car frames, offer as much space as possible in the floor area, in order for it to accommodate the batteries of the vehicle.

Batteries are relatively heavy and bulky components that due to their weight are preferably accommodated in the vehicle frame in the lowest possible position in order to hinder the vehicle dynamics as little as possible. Normally batteries are shaped in the shape of a parallelepipedic box with a very long and wide base. They also extend mainly in the longitudinal vehicle direction and have a reduced height in order to allow for free space for the vehicle's inner compartment. The position of the batteries causes the traditional vehicle floor geometry to be completely redesigned in order to fulfil both a security function, as well as a battery accommodation function.

DE202010017552U1 discloses a body structure, in particular floor structure, for a motor vehicle, with structural components defining load paths for crash situations. In the area of the structural components that are placed in at least one defined load path, in particular a front crash load path and/or a side crash load path and/or a rear crash load path, the components are formed at least in part by high-strength structural components, preferably by completely hardened or at least partially hardened high-strength structural components, from a hot-stamping or cold-stamping steel sheet, which are directly or indirectly, preferably directly, connected to one another, in particular via a force and/or shape and/or material connection.

Document WO2021/094405 A1 discloses a hot stamping vehicle floor for a vehicle frame.

### SUMMARY

In a first aspect of the present disclosure, a method for forming a floor panel for a vehicle framework is provided. The method comprises providing a main blank made of a press-hardenable steel, providing one or more first patch blanks and welding the first patch blanks to the main blank to form a patchwork blank. The method further comprises pressing the patchwork blank to form the floor panel. Herein, the first patch blanks are arranged along a part of the main blank to form a first seat cross member, and left and right portions of the first patch blanks in an area of the main blank to form an area of the floor panel to be attached to a rocker are made of a steel that is more ductile than the steel of the main blank.

In accordance with this aspect, a method for forming a floor panel is provided which can simplify the manufacturing process and at the same time a floor panel is provided which has sufficient strength and stiffness, and energy absorption in the case of impact while reducing the weight of the floor panel.

Throughout the present disclosure the main blank may be regarded as a blank (e.g. a metal sheet or thin metal plate) that will form the main structure of the floor panel. A patch blank may be regarded as a blank that will form a local patch on the main structure of the floor panel.

In examples, the patchwork blank may have overlapping soft (or “ductile”) and hard materials in areas conceived to withstand compressive crash forces in case of a crash situation. In these areas, the floor panel can withstand more deformation (e.g. higher bending angles) without the risk of rupture and can make the vehicle safer.

The first seat cross member may be the front seat cross member or the rear cross member. A seat cross member may herein be regarded as a portion of the floor panel extending in a transverse direction which provides stiffness and strength. The seat cross members may form anchoring points and be configured for attachment of seats of the vehicle.

The first patch blanks may be arranged along a part of the main blank destined to form a first seat cross member, but they do not necessarily need to cover the entire cross member, i.e. only specific portions of the cross member may be covered.

Welding of the first patch blanks may be carried out by one or more methods of the group consisting of resistance spot welding, standard laser welding, remote laser welding, resistance seam welding (RSEVV), gas metal arc welding and laser and arc hybrid welding.

In examples, the first patch blanks may include a central portion, and the central portion of the first patch blanks between the left and right portions may be made of a press-hardenable steel. In these examples, a patch blank in the central area between portions that are attached to the rockers may provide a local increase in strength and stiffness. The thickness of the floor panel may be locally increased in this central area.

Optionally, providing the one or more first patch blanks comprises forming a first tailor welded blank to be arranged along the part of the main blank to form the first seat cross member, wherein the first tailor welded blank comprises the left, central and right portions of the first patch blanks. In these examples, a manufacturing process including tailoring mechanical properties over the entire width of the seat cross member may be further optimized.

In some examples, the method may further comprise providing one or more second patch blanks and welding the second patch blanks to the main blank. Herein, the second patch blanks may be arranged along a part of the main blank to form a second seat cross member, and left and right portions of the second patch blanks in an area of the main blank to form an area of the floor panel to be attached to the rocker are made of a steel that is more ductile than the steel of the main blank. In these examples, both the front and rear seat cross members may include the patch blanks.

In some examples, providing the main blank comprises creating left and right openings in the main blank by cutting out left and right portions of the main blank, and wherein the left and right portions of the first patch blanks are welded to the main blank to cover the left and right openings. A method for forming a floor panel for a vehicle framework is thus provided. The method comprises providing a main blank made of a press-hardenable steel, and creating openings in the main blank by cutting out left and right portions of the main blank. The method further comprise providing one or more first patch blanks and welding the first patch blanks to the main blank to cover the left and right openings to form a patchwork blank. The method further comprises pressing the patchwork blank to form the floor panel. Herein, the first patch blanks are arranged along a part of the main blank to form a first seat cross member, and left and right portions of the first patch blanks in an area of the main blank to form an area of the floor panel to be attached to a rocker are made of a steel that is more ductile than the steel of the main blank. The first patch blanks may include further portions beyond the left and right portions, but not necessarily.

In these examples, tailoring of mechanical properties of local more ductile areas for energy absorption and for controlling kinematics in deformation may be combined with a further weight reduction.

In some examples, the pressing of the patchwork blank comprises heating the patchwork blank above an austenization temperature and hot stamping the patchwork blank. In other examples, the pressing of the patchwork blank comprises cold pressing the patchwork blank, and subsequently heating the pressed patchwork blank to above an austenization temperature, and subsequently cooling the heated and pressed patchwork blank.

Within the scope of the present disclosure, both indirect and direct hot stamping may be used. In direct hot stamping, a blank (and more particularly for the present disclosure a patchwork blank) may be heated above an austenization temperature to achieve a partial or fully austenite microstructure. In particular, the blank may be heated above the corresponding Ac3 temperature. After heating above an austenization temperature for a period of time, the blank is subjected to a deformation or drawing process in a press. Then, the deformed blank may be cooled. Depending on the type of steel used, and depending on the cooling rate of the material, a martensite microstructure may be obtained in at least part of the deformed blank. In some cases, in order to achieve a martensitic microstructure, it may be necessary to rapidly quench the blank. A critical cooling rate may be e.g. around 25-30° C./s. Quenching may be carried out in the press. In some examples, “passive cooling” (i.e. leaving the deformed blank to cool by air) may be sufficient to obtain the martensitic microstructure.

In indirect hot stamping, the blank (and in the present disclosure the patchwork blank) is deformed in “cold conditions”, e.g. at room temperature. Only after deforming the blank, the blank may be subjected to a heat treatment to obtain the aforementioned martensitic microstructure. After deforming, the blank may be heated to above an austenization temperature and then cooled.

In further examples, a multistep process and a multistep press may be used. In a multistep process, in a single press apparatus, different blanks undergo different manufacturing steps at the same time. For example, in a first station of such a press apparatus, a first press operation may be performed, in a second station a cooling operation may be performed, and in a third station, a trimming process may be performed. In further stations, further post-processing steps (e.g. calibration, cutting, holes) etc. may be performed. A multistep process may also combine more than one forming station. In examples, no cooling station is required. Multistep processes may be used both with air hardenable steels, and other UHSS requiring quenching to obtain a martensitic microstructure.

In some examples, the main blank and the central portion may be made from boron steel, and specifically from the same boron steel. Boron steels are suitable for hot stamping and very high strengths may be obtained. For example 22MnB5 or 22MnB8 steels may be used.

Examples of hardenable boron steel include UHSS such as 22MnB5 steel or Usibor® 1500 or 2000, Usibor® being commercially available from Arcelor Mittal.

In order to avoid the decarburization and the scale formation during the forming process, 22MnB5 may be presented with an aluminum-silicon coating. The composition of 22MnB5 is summarized below in weight percentages (rest is iron (Fe) and impurities):

| | |
|---|---|
| C | 0.20-0.25 |
| Si | 0.15-1.35 |
| Mn | 1.10-1.25 |
| P | <0.025 |
| S | <0.008 |
| Cr | 0.15-0.30 |
| Ti | 0.02-0.05 |
| B | 0.002-0.004 |
| N | <0.009 |

Several 22MnB5 steels are commercially available having a similar chemical composition. However, the exact amount of each of the components in a 22MnB5 steel may vary slightly from one manufacturer to another. Other ultra-high strength steels include e.g. BTR 165, which is commercially available from Benteler.

Usibor® 1500 is supplied in ferritic-perlitic phase. It is a fine grain structure distributed in a homogenous pattern. The mechanical properties are related to this structure. After heating, a hot stamping process, and subsequent quenching, a martensite microstructure is created. As a result, maximal strength and yield strength increase noticeably.

The composition of Usibor® 1500 is summarized below in weight percentages (rest is iron (Fe) and unavoidable impurities):

| C | Si | Mn | P | S | Cr | Ti | B | N |
|---|---|---|---|---|---|---|---|---|
| 0.24 | 0.27 | 1.14 | 0.015 | 0.001 | 0.17 | 0.036 | 0.003 | 0.004 |

Usibor® 2000 is another boron steel with even higher strength. After a hot stamping die quenching process, the yield strength of Usibor® 2000 may be 1400 MPa or more, and the ultimate tensile strength may be above 1800 MPa. A composition of Usibor® 2000 includes a maximum of 0.37% of carbon, a maximum of manganese of 1.4%, a maximum of 0.7% of silicon and a maximum of 0.005% of boron by weight.

The left and right portions of the first patch blanks to form an area of the floor panel to be attached to a rocker may be made of a more ductile steel (after hot forming) than the main blank. These portions may for instance be made of Ductibor® 500 or Ductibor® 1000, also commercially available from Arcelor Mittal, or of CRL 340 LA.

Ductibor® and other softer steels on the other hand may also be used in hot forming, or in hot forming die quenching. However, these steels will not have a martensitic microstructure as a result. The resulting steel will have a lower ultimate tensile strength and a lower yield strength, but will have a higher elongation at break.

Ductibor® 400 may have an ultimate tensile strength of 450 MPa or more, Ductibor® 500 of 550 MPa or more, and Ductibor® 1000 of 1000 MPa or more.

CRL-340LA is a steel that is commercially available from SSAB. It is a high-strength low-alloy steel intended for general presswork, bending and forming. Its composition is outlined in the following (weight percentages).
C max 0.1%
Si max 0.040%
Mn max 1%
P max 0.030%
S max 0.025%
Al min 0.015%)
Nb+Ti max 0.1%

In examples, the patches are designed to have more ductile properties than the main piece. The patches may in examples be made from any steel that is suitable for forming, including hot forming and cold forming and that provide the suitable mechanical properties after such a process. Ductibor®, CRL-340LA and similar steels, e.g. low alloy steel, may be suitable for “softer” patches.

The combination of a softer patch with a “harder” main piece allows the floor panel to absorb more energy in case of e.g. a collision. Another aspect is that the rupture of the main blank of the floor panel when subjected to a bending load can be avoided or only occurs after significant deformation.

Patch blanks may be made in general of a steel having greater ductility than the material of the main blank, for example, the patch may be made of very high strength steel (VHSS) or extra high strength steel (EHSS).

Herein, EHSS may be regarded as a steel (after forming, or in the final product) having a yield strength between 550 and 800 MPa. VHSS may be regarded as a steel (after forming, or in the final product) having a yield strength between 390 MPa and 550 MPa.

In some examples, the main blank may have a thickness between 0.5 and 3 mm, and specifically between 0.8 and 1.5 mm. The main blank and the patch blanks may have the same or similar thickness. In general, a thickness in most vehicle applications may be between 0.5 and 6 mm, and specifically between 0.5 and 3 mm, and more specifically between 0.8 and 1.5 mm.

In a further aspect, a floor panel for a vehicle framework made from a single integral piece is provided. The floor panel extends in a longitudinal direction from a front to a back and in a transverse direction between a left attachment area for attachment to a left rocker, and a right attachment area for attachment to a right rocker. The floor panel includes a front seat cross member, and a rear seat cross member, and the front and rear seat cross members include left and right attachment portions for attachment to the left and the right rocker respectively. The floor panel includes a main hard area, and a secondary ductile area, wherein the main hard area includes a central portion of the front and rear seat cross members, and the second ductile area includes the left and right attachment portions. The secondary ductile area has a tensile strength that is lower than the tensile strength of the main hard area, and an elongation at break that is higher than the elongation at break of the main hard area.

In accordance with this aspect, a floor panel is provided which, at relatively low weight, provides a good equilibrium between stiffness and strength and energy absorption and safety in the case of impact.

Examples of the vehicle floor according to the present disclosure can significantly reduce the number of parts required to obtain the final vehicle floor. This leads to a simplification and cost reduction in the manufacturing process, because less parts need to be separately formed and lately joined together by welding. Furthermore, the possibility of using more hot-stamping sheet metal blanks, the thickness of the parts can also be reduced and together with the amount of single part reduction, a relevant weight reduction can be achieved.

In some examples, the secondary ductile area may extend substantially from the front to the back along the left and right attachment areas. In these examples, substantially along the entire length of the rocker, a more ductile area is provided. Cracks along the entire welding joint of the rocker and floor panel (which may both be formed from an UHSS of low ductility but high strength) may be reduced or avoided.

In some examples, the secondary ductile area may substantially correspond to the left and right attachment portions of the front and rear seat cross members.

In some examples, the secondary ductile area may have a length along the longitudinal direction of between 10 and 50 cm, and a width along the transverse direction of between 15 and 60 cm.

In some examples, the tensile strength of the main hard area may be higher than 1.200 MPa, and specifically higher than 1.400 MPa, and wherein the tensile strength of the secondary ductile area may have a tensile strength between 500 and 1.000 MPa.

In examples, a patch blank (after hot forming) may be between 10% and 80% more ductile the main blank. An ultimate tensile strength (after hot forming) of the patch blanks may be between 25% and 70% lower than the ultimate tensile strength of the main blank.

Ultimate tensile strength (UTS) (also called “tensile strength) may herein be regarded as the maximum stress that a material can withstand while being stretched or pulled before breaking.

The ultimate tensile strength may be found by performing a tensile test and recording the engineering stress versus strain. The highest point of the stress-strain curve is the ultimate tensile strength and has units of stress.

In examples, the floor panel may be obtainable by a method according to any of the examples herein explained.

The term “ductility” as used in the present disclosure refers to the measure of the material's ability to undergo a plastic deformation before breaking. Ductility may be more commonly expressed as percent elongation or percent area reduction at break from a standard tensile test according to the following ISO norm: ISO 6892-1:2016 Metallic materials-tensile testing. Method of test at room temperature.

One way for calculating the ductility is based on the percentage elongation of a metal probe during such a tensile test, as follows:

$$\% Elongation = ( Lf - Lo ) / Lo$$

Herein, Lo is the initial probe length, while Lf is the probe length at break.

Another way to measure ductility is with area reduction.

$$\% Area reduction = ( Ao - Af ) / Ao$$

Herein, A is the initial cross-section of a probe cross section, while Af is the probe cross section at breaking.

### BRIEF DESCRIPTION OF THE DRAWINGS

Non-limiting examples of the present disclosure will be described in the following, with reference to the appended figures, in which:

FIG. 1A schematically illustrates a perspective view of a vehicle floor according to the state of the art;

FIG. 1B schematically illustrates a perspective view of an example of a vehicle floor panel according to the present disclosure;

FIGS. 2A-2C schematically illustrate a further example of a vehicle floor panel;

FIGS. 3A-3C schematically illustrate behaviour of an example of a vehicle floor panel according to the present disclosure in comparison with alternative designs;

FIG. 4 schematically illustrates yet a further example of a vehicle floor panel according to the present disclosure; and

FIGS. 5A and 5B schematically illustrate two examples of methods of manufacturing of a vehicle floor panel.

### DETAILED DESCRIPTION OF EXAMPLES

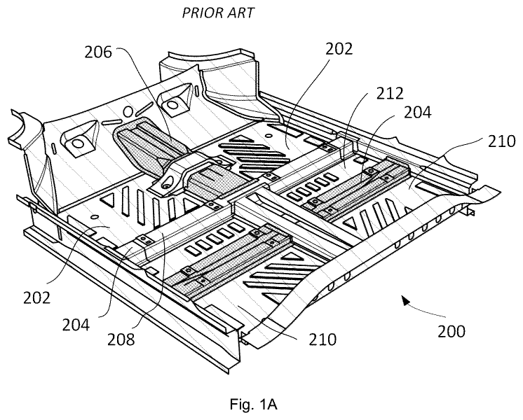

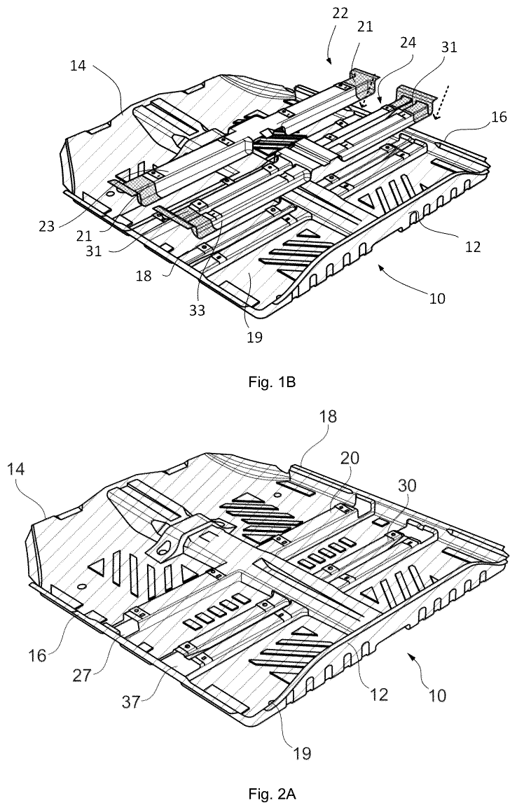

FIG. 1A shows a vehicle floor 200 according to the prior art. This vehicle floor of the state of the art comprises a plurality of sheet metal parts, including front panels 202, cross beams 204, longitudinal beams 206, beam reinforcements 208, rear panels 210, middle panel 212 and others.

This vehicle floor 200 may be made up from 16 independent sheet metal parts in total. These 16 parts are formed independently (in separate forming processes) and then are joined by any suitable welding process, such spot welding, laser welding or the like. Once finished, the vehicle floor 200 may have a weight of more than 30 kg.

FIG. 1B schematically illustrates a floor panel and a method of manufacture according to examples of the present disclosure. It may be seen that the single integral piece 10 incorporates e.g. a front seat cross member, and a rear seat cross member and also longitudinal beam portions, and panels, which in the example of FIG. 1 are separately manufactured and afterwards joined.

FIG. 1B illustrates how two patch blanks may be added to a main piece as illustrated by the arrows drawn in interrupted lines. Even though the patch and main piece are shown in this FIG. 1B in their “ready” state, i.e. after hot forming, it should be noted that in this example, a flat patch blank and a flat main piece blank are joined to each other prior to the hot stamping process.

The floor panel 10 for a vehicle framework is made from a single integral piece. The floor panel 10 extends in a longitudinal direction from a front 14 to a back 12 and in a transverse direction between left attachment area 18 for attachment to a left rocker (on the driver's side), and a right attachment area 16 for attachment to a right rocker.

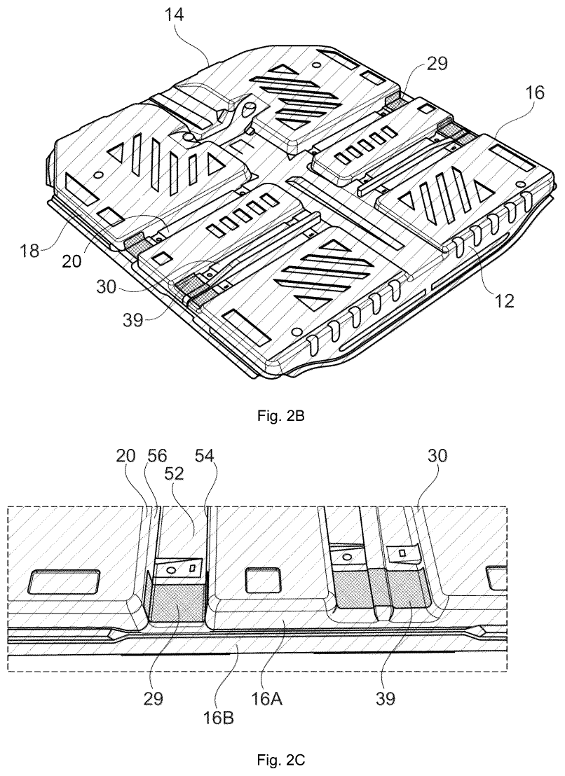

The floor panel includes a front seat cross member 20, and a rear seat cross member 30, and the front and rear seat cross members 20, 30 include left and right attachment portions for attachment to the left and the right rocker respectively (see also FIG. 2A).

The floor panel includes a main hard area 19 (in lighter hatching), and a secondary ductile area 21, 31 (in denser hatching). The main hard area includes a central portion of the front and rear seat cross members 20, 30, and the secondary ductile area 21, 31 includes the left and right attachment portions. The secondary ductile area has a tensile strength that is lower than the tensile strength of the main hard area, and an elongation at break that is higher than the elongation at break of the main hard area.

The floor panel 10 may be manufactured using a method comprising providing a main blank 19 made of a press-hardenable steel, providing one or more first patch blanks 22 and welding the first patch blanks 22 to the main blank to form a patchwork blank.

The method may further comprise pressing the patchwork blank to form the floor panel 10, wherein the first patch blanks 22, are arranged along a part of the main blank 19 to form a first seat cross member 20. The first patch blanks 22 may cover substantially a complete width of the floor panel, from one rocker attachment area to another rocker attachment area.

Left and right portions 21 of the first patch blanks 22 in an area of the main blank 19 to form an area of the floor panel 10 to be attached to a rocker are made of a steel that is more ductile than the steel of the main blank.

In some examples, the ductile areas may have a length along the longitudinal direction of between 10 and 50 cm, and a width along the transverse direction of between 15 and 60 cm.

In the example of FIG. 1B, a central portion 23 of the first patch blanks 22 between the left and right portions may be made of a press-hardenable steel, and specifically the same steel as the main blank.

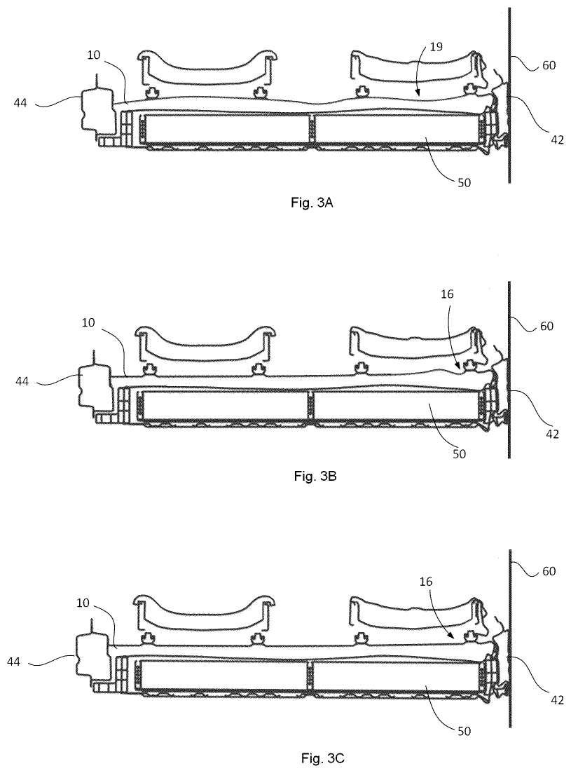

In the example of FIG. 1B, local ductility is provided in the attachment of seat cross members (integrated in the floor panel). With reference to FIG. 3, the advantages of such a floor panel in the case of impact will be explained.

In the example of FIG. 1B, providing the one or more first patch blanks comprises forming a first tailor welded blank (TWB) 22 to be arranged along the part of the main blank to form the first seat cross member 20, wherein the first tailor welded blank 22 comprises the left 21, central 23 and right 21 portions of the first patch blanks. In other examples, instead of a single TWB, several separate patch blanks may be used.

In the example of FIG. 1B, the method further comprises providing one or more second patch blanks 24 and welding the second patch blanks 24 to the main blank 19. The second patch blanks are arranged along a part of the main blank to form a second seat cross member 30 (in this case, the rear seat cross member). The second patch blanks 24 may extend over substantially the entire width of the floor panel i.e. from an attachment area to one rocker to an attachment are to the other rocker.

Left and right portions 31 of the second patch blanks in an area of the main blank to form an area of the floor panel to be attached to the rocker are made of a steel that is more ductile than the steel of the main blank. In this example, both the rear and the front seat cross member may have a similar construction, and may both be made by providing a TWB 22, 24 which substantially extends from one side 18 to the other side 16 of the floor panel, and is welded on top of the main blank. I.e. the blanks overlap.

Any suitable welding technique may be used, including e.g. resistance spot welding, standard laser welding, remote laser welding (laser welding wherein the laser head may have a distance of 50 cm or more to the weld zone), resistance seam welding (RSEVV), gas metal arc welding and laser and arc hybrid welding.

The main blank 19 and the central portion 23, 33 may be made from boron steel, and specifically from the same boron steel. E.g. 22MnB5 or 22MnB8 steels may be used. The steels may have a coating, e.g. an AlSi coating or a Zn coating.

FIGS. 2A and 2B schematically illustrate a top view and a bottom view respectively of a floor panel 10 according to a different example. In general, the same reference signs have been used to denote the same or similar elements, including the rear 12 and front 14 of the floor panel, and the areas 18, 16 which are to be attached to the right rocker, or left rocker of the vehicle framework.

As in the example of FIG. 1, patch blanks may be welded to the main blank 19 prior to a stamping process. However, in this example, providing the main blank in this case comprises creating left and right openings 27, in the main blank by cutting out left and right portions 27, of the main blank 19, and wherein the front and rear portions 29 of the first patch blanks (in the figure, left and right) are welded to the main blank to cover the left and right openings 27. There is therefore less overlap between the patch blanks and the main blank. Weight of the floor panel may be optimized. In the example, front and rear openings 27, 37 and corresponding front and rear portions 29, 39 are provided both for the front seat cross member 20, and the rear seat cross member 30.

FIG. 2C illustrates a detailed view of the patch blanks 29, 39 added to the seat cross members 20, 30. As may be seen in FIG. 2C, the seat cross members may have a U-shaped cross-section including a bottom portion 52 and a first sidewall 54 and a second sidewall 56.

In the example of FIG. 2C, the patch blanks may cover a bottom wall of the U-shaped cross-section of the cross member. Particularly, the patch blanks may cover the bottom wall and extend into the first and second sidewalls 54, 56. The patch blanks may extend from a fillet between the first sidewall 54 and bottom 52 to the fillet between the second sidewall 56 and bottom 52.

The attachment area 16 of the floor panel to the rocker in this example may include first and second substantially planar portions 16A, 16B which are attached to different planar support areas of the rocker.

In the example of FIG. 1B, the first and second portions of the patch blanks are wider and may extend to the edges of the floor panel.

FIGS. 3A-3C schematically illustrate a comparison of deformation in a side pole crash of different configuration. In FIGS. 3A-3C, cross-sectional views of the floor panel at a longitudinal position of a seat cross member are provided. In the tests, a pole 60 impacts a left rocker panel 42. The seat cross member of panel 10 extends from right rocker 44 to left rocker 42.

In FIG. 3A, the seat cross member in this example is formed by an overlap of a more ductile patch on the main blank. The ductile part extends substantially over the entire width of the floor panel, i.e. from the left 42 to the right rocker 44.

In the case of a crash, there is a danger of too much deformation as indicated by reference sign 19. The locally high deformation of the floor panel represents a risk for damage to the battery area 50.

In FIG. 3B, in order to avoid this problem, a patch blank extending over the entire width of the seat cross member is made from the same material as the main blank, e.g. boron steel. The resulting structure is stronger and stiffer and therefore deforms less than in the example of FIG. 3A. However, there is a significant risk of rupture in the areas close to reference sign 16. Local bending can be close to a breaking limit.

In FIG. 3C, a floor panel according to the present disclosure (in this particular case according to FIG. 1B) is shown in the case of a pole crash. That is, locally a ductile patch is provided in the attachment area of the seat cross member to the rocker. It may be seen in FIG. 3C, that deformation is less than in the case of FIG. 3A, so there is no risk for the integrity of the battery box 50. The local deformation and bending in the area 16 may be somewhat reduced as compared to the example of FIG. 3B. Even if the same local deformation and bending were present, there would be much less risk of rupture because the ductile patch allows higher bending angles before rupture.

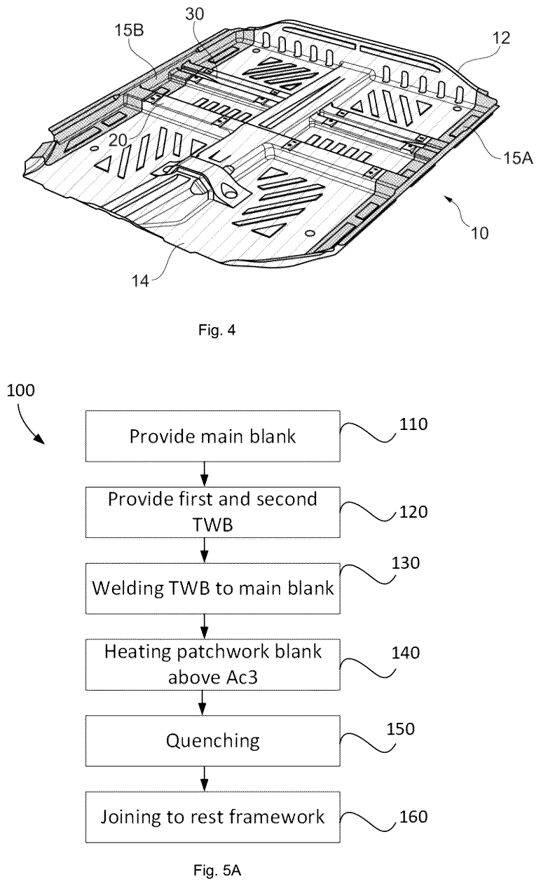

FIG. 4 schematically illustrates yet a further example of a vehicle floor panel according to the present disclosure. In the case of FIG. 4, the floor panel 10 may be formed from a single integral piece in a single stamping procedure as for the examples of FIGS. 1B and 2.

In the example of FIG. 4, the secondary ductile area extends substantially from the front to the back along the left and right attachment areas 15A, 15B. That is, along the entire length of the floor panel, at the attachment areas to the rocker, ductility is increased. This may be achieved by providing relatively large patch blanks and weld them to the main blank along the attachment areas, and subsequent hot stamping the floor panel.

In further examples, the floor panel may be made from a single main blank, wherein the areas that are to be attached to the rocker undergo a different heat treatment. In examples, the side portions of the main blank may not be heated to an austenization temperature. In further examples, partial tempering may be carried out in a furnace to create different areas in the main blank with different temperatures before deforming.

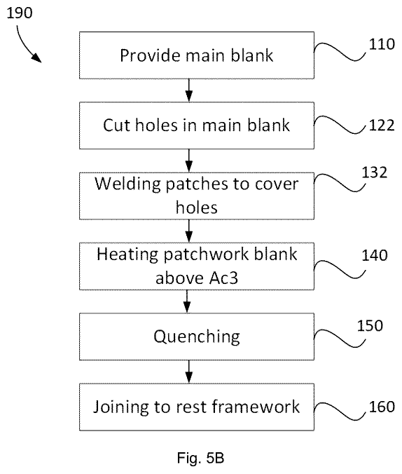

FIGS. 5A and 5B schematically illustrate two examples of methods of manufacturing of a vehicle floor panel. The method illustrated in FIG. 5A may be suitable particularly for the floor panel of FIG. 1B. The method illustrated in FIG. 5B may be particularly suitable for the floor panel of FIG. 2.

At block 110, a main blank may be provided. The main blank may be made from an UHSS, particularly a boron steel. The main blank may have a thickness of e.g. between 0.5 and 3 mm.

At block 120, first and second TWB are provided. The first TWB may be arranged in an area of the main blank that will be deformed to form a first seat cross member, e.g. the front seat cross member. The second TWB may be arranged in an area of the main blank that will be deformed to form a second seat cross member, e.g. the rear seat cross member.

The first and second TWB may include portions of a steel that is more ductile than the steel of the main blank. The portions of the TWB that will be arranged in the area of attachment to the rockers may be more ductile. Central portions of the TWB may be of a harder steel.

At block 130, the two TWB may be welded to the main blank to form a patchwork blank.

Then, at block 140, the patchwork blank may be heated to above an austenization temperature, in particular above Ac3. The heating temperature may be above Ac3 a and below an evaporation temperature of a coating of the blanks. In examples, the heating temperature may be between 87° and 950° C.

After a suitable heating time, e.g. a few minutes, to ensure that the whole patchwork blank has an austenitic microstructure, the patchwork blank may be quenched at block 150. In particular, the die or press used for deforming the patchwork blank may have integrated cooling channels. Cold liquid (e.g. water) may be provided through the cooling channels to rapidly cool the patchwork blank to below 400° C., specifically below 300° C. or to about 200° C. or less.

The steels of the main blank and the central portion of the seat cross members may obtain a martensite microstructure as a result and may have an ultimate tensile strength of between 1.400 MPa and about 2.000 MPa. The yield strength of these parts may be above 800 MPa.

The steel of the ductile portions of the blanks may have an ultimate tensile strength of between 400 MPa and 1.000 MPa, and specifically between 500 MPa and 1.000 MPa.

At block 160, the obtained floor panel may be joined to the rest of the framework of the vehicle. The floor panel may be joined e.g. to the rockers. Spot welding and other joining operations may be used for such operations. Before joining to other parts of the framework, post processing operations may be carried out including e.g. trimming, notching, calibration. In examples, such post processing operations may be carried out in the same (multistep) press apparatus.

In the example of FIG. 5B, an alternative manufacturing method 190 of a floor panel is provided. A main blank 110 may be provided at block 110. Before deforming the main blank, i.e. when the main blank is substantially flat, holes may be cut (e.g. with laser cutting) in the main blank, at block 122.

At block 132, patch blanks may be welded to the main blank to cover the holes. The remaining steps of the method 190 may be substantially the same as in the method 100 of FIG. 5A.

In examples of the present disclosure, floor panels that have sufficient strength and stiffness and absorption ability to comply with relevant tests including crash tests may be provided with a weight reduction of 10% or more, even 20% as compared to the state of the art floor panel of FIG. 1 may be provided.

Although only a number of examples have been disclosed herein, other alternatives, modifications, uses and/or equivalents thereof are possible. Furthermore, all possible combinations of the described examples are also covered. Thus, the scope of the present disclosure should not be limited by particular examples, but should be determined only by a fair reading of the claims that follow.

1. A method for forming a floor panel for a vehicle framework, comprising:
providing a main blank made of a press-hardenable steel;
providing one or more first patch blanks;
welding the first patch blanks to the main blank to form a patchwork blank; and
pressing the patchwork blank to form the floor panel, wherein
the first patch blanks are arranged along a part of the main blank configured to form a first seat cross member, wherein
left and right portions of the first patch blanks in an area of the main blank that is configured to form an area of the floor panel configured to be attached to a rocker are made of a steel that is more ductile than the steel of the main blank, and wherein
a central portion of the first patch blanks between the left and right portions is made of a press-hardenable steel.

2. The method of claim 1, wherein providing the one or more first patch blanks comprises forming a first tailor welded blank to be arranged along the part of the main blank configured to form the first seat cross member, and wherein the first tailor welded blank comprises the left, central and right portions of the first patch blanks.

3. The method of claim 1, further comprising:
providing one or more second patch blanks;
welding the second patch blanks to the main blank to form the patchwork blank, wherein
the second patch blanks are arranged along a part of the main blank configured to form a second seat cross member, and wherein left and right portions of the second patch blanks in an area of the main blank that is configured to form an area of the floor panel configured to be attached to the rocker are made of a steel that is more ductile than the steel of the main blank.

4. The method of claim 1, wherein providing the main blank comprises creating left and right openings in the main blank by cutting out left and right portions of the main blank, and wherein the left and right portions of the first patch blanks are welded to the main blank to cover the left and right openings.

5. The method of claim 1, wherein the pressing of the patchwork blank comprises heating the patchwork blank above an austenization temperature and hot stamping the patchwork blank.

6. The method of claim 1, wherein the pressing of the patchwork blank comprises cold pressing the patchwork blank, and subsequently heating the pressed patchwork blank to above an austenization temperature, and subsequently cooling the heated and pressed patchwork blank.

7. The method of claim 5, wherein the main blank and the central portion are made from boron steel.

8. The method of claim 7, wherein the main blank and the central portion are made from the same boron steel.

9. The method of claim 1, wherein the main blank has a thickness between 0.5 and 3 mm.

10. A floor panel for a vehicle framework made from a single integral piece, wherein
the floor panel extends in a longitudinal direction from a front to a back and in a transverse direction between a left attachment area for attachment to a left rocker, and a right attachment area for attachment to a right rocker, and wherein the floor panel includes a front seat cross member, and a rear seat cross member, and the front and rear seat cross members including left and right attachment portions for attachment to the left and the right rocker respectively, and
the floor panel includes a main hard area, and a secondary ductile area,
wherein the main hard area includes a central portion of the front and rear seat cross members, and the secondary ductile area includes the left and right attachment portions,
wherein the secondary ductile area has a tensile strength that is lower than the tensile strength of the main hard area, and an elongation at break that is higher than the elongation at break of the main hard area.

11. The floor panel of claim 10, wherein the secondary ductile area extends substantially from the front to the back along the left and right attachment areas.

12. The floor panel of claim 10, wherein the secondary ductile area substantially corresponds to the left and right attachment portions of the front and rear seat cross members.

13. The floor panel of claim 10, wherein the secondary ductile area has a length along the longitudinal direction of between 10 and 50 cm, and a width along the transverse direction of between 15 and 60 cm.

14. The floor panel of claim 10, wherein the tensile strength of the main hard area is higher than 1,200 MPa, and wherein the tensile strength of the secondary ductile area is has a tensile between 500 and 1,000 MPa.

15. The floor panel of claim 10, wherein the floor panel is obtained by a method according to claim 1.

16. A method for forming a floor panel for a vehicle framework, comprising:
providing a main blank made of a press-hardenable steel;
attaching one or more first patch blanks to the main blank to form a patchwork blank; and
pressing the patchwork blank to form the floor panel, wherein
the floor panel includes a first seat cross member, and the first seat cross member includes left and right attachment portions for attachment to a left and a right rocker of the vehicle framework respectively, and
wherein a central portion of first seat cross member has a first tensile strength and a first elongation at break, and
wherein the left and right attachment portions have a tensile strength that is lower than the first tensile strength, and an elongation at break that is higher than the first elongation at break.

17. The method of claim 16, wherein pressing the patchwork blank comprises heating the patchwork blank to above an austenization temperature and hot stamping the patchwork blank.

18. The method of claim 17, wherein attaching the first patch blanks comprises welding the first patch blanks to the main blank.

19. The method of claim 16, the first tensile strength is higher than 1,200 MPa.

20. The method of claim 16, comprising providing a first tailor welded blank to be arranged along the part of the main blank configured to form the first seat cross member, and wherein the first tailor welded blank comprises the first patch blanks.
